(19) United States
(12) Patent Application Publication
(10) Pub. No.: US 2009/0009053 A1
(43) Pub. Date: Jan. 8, 2009

(54) FIELD EMISSION DEVICE ARRAY SUBSTRATE AND FABRICATING METHOD THEREOF

(75) Inventors: Chen-Chun Lin, Hsinchu City (TW); Fu-Ming Pan, Hsinchu County (TW); Kai-Chun Chang, Taoyuan County (TW); Chuan-Wen Kuo, Taichung City (TW); Mei Liu, Pingtung County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/954,245

(22) Filed: Dec. 12, 2007

(30) Foreign Application Priority Data
Jul. 6, 2007 (TW) 96124672

(51) Int. Cl. H01J 1/62; H01J 9/02

(52) U.S. Cl. 313/495; 445/24

(57) ABSTRACT

A fabricating method of a field emission device array substrate is provided, which includes the following steps. First, a substrate is provided. Then, a cathode conductive layer is formed on the substrate. Moreover, an anodized layer with a plurality of holes is formed on the cathode conductive layer. Thereafter, a plurality of electron emitters is formed within the holes respectively. Additionally, an insulation layer is formed to cover the electron emitters and the anodized layer. Then, a gate material layer is formed on the insulation layer. Thereafter, the gate material layer is patterned to form a gate layer. The gate layer and the insulation layer have an opening to expose the electron emitters.

### CROSS-REFERENCE TO RELATED APPLICATION

This application claims the priority benefit of Taiwan application serial no. 96124672, filed on Jul. 6, 2007. The entirety of the above-mentioned patent application is hereby incorporated by reference herein and made a part of this specification.

### BACKGROUND OF THE INVENTION

1. Field of the Invention

The present invention relates to a field emission device array substrate and a fabricating method thereof. More particularly, the present invention relates to a field emission device array substrate with high reliability and a fabricating method thereof.

2. Description of Related Art

The lighting principle of a field emission device is mainly to use an electric field generated between a cathode plate and an anode plate to attract electrons from the tip of carbon nanotubes under vacuum condition. Under the effect of the electric field, the electrons move from the cathode plate to the anode plate, and hit the phosphor layer on the cathode plate to generate luminescence.

FIGS. 1A-1D are schematic cross-sectional views of a conventional field emission device array substrate during the fabrication processes. Firstly, referring to FIG. 1A, a cathode conductive layer 12, an insulation layer 14, and a gate layer 16 are formed on a substrate 10 sequentially. Then, referring to FIG. 1B, the opening 18 is formed in the insulation layer 14 and the gate layer 16 to expose part of the cathode conductive layer 12. Then, referring to FIG. 1C, an anodized layer 26 is formed on the cathode conductive layer 12. It should be noted that the method for forming the anodized layer 26 includes: firstly, forming a metal layer on the cathode conductive layer 12 in the opening 18, and performing an anodization process on the metal layer to form a plurality of holes 28. Then, referring to FIG. 1D, a plurality of carbon nanotubes 32 are formed in the holes 28.

It should be noted that the problem of volume expansion occurs in the metal layer after the anodization process. So the metal layer having an expanded volume is limited by the inner wall of the opening 18, thus generating undesirable stresses, which will possibly cause a stripping problem of the anodized layer 26. Moreover, the carbon nanotubes 32 formed in the holes 28 may also cause the undesirable electrical conduction between the neighboring gate layer 16 and cathode conductive layer 12. Furthermore, during the anodization process, the gate layer 16 is also affected by the anodization undesirably. Thus the reliability of the conventional field emission device array substrate is reduced.

### SUMMARY OF THE INVENTION

The present invention provides a fabricating method of a field emission device array substrate, which can effectively improve the process yield rate.

The present invention provides a field emission device array substrate with good reliability.

The present invention provides a fabricating method of a field emission device array substrate, which includes the following steps. First, a substrate is provided. Then, a cathode conductive layer is formed on the substrate. Then, an anodized layer with a plurality of holes is formed on the cathode conductive layer. Thereafter, a plurality of electron emitters is formed within the holes respectively. Additionally, an insulation layer is formed to cover the electron emitters and the anodized layer. Then, a gate material layer is formed on the insulation layer. Thereafter, the gate material layer is patterned to form a gate layer. The gate layer and the insulation layer have an opening to expose the electron emitters.

In an embodiment of the present invention, the electron emitters include carbon nanotubes.

In an embodiment of the present invention, the method of forming the electron emitters includes chemical vapor deposition.

In an embodiment of the present invention, the material of the anodized layer includes aluminum oxide.

In an embodiment of the present invention, the material of the insulation layer includes silicon nitride, silicon oxide, or silicon oxynitride.

In an embodiment of the present invention, the material of the gate layer includes metal, alloy, or doped semiconductor.

The present invention provides a field emission device array substrate, which includes a substrate, a cathode conductive layer, an anodized layer, a plurality of electron emitters, an insulation layer, and a gate layer. The cathode conductive layer is disposed on the substrate. Moreover, the anodized layer is disposed on the cathode conductive layer and has a plurality of holes. The electron emitters of the present invention are disposed within the holes respectively. Additionally, the insulation layer covers the anodized layer and the electron emitters, and the gate layer is disposed on the insulation layer. The insulation layer and the gate layer have an opening to expose the electron emitters.

In an embodiment of the present invention, the electron emitters include carbon nanotubes.

In an embodiment of the present invention, the material of the anodized layer includes aluminum oxide.

In an embodiment of the present invention, the material of the insulation layer includes silicon nitride, silicon oxide, or silicon oxynitride.

In an embodiment of the present invention, the material of the gate layer includes metal, alloy, or doped semiconductor.

The fabricating method of a field emission device array substrate according to the present invention is to fabricate the anodized layer on the cathode conductive is layer directly. Therefore, the anodized layer of the present invention will not be affected by undesirable stresses, thus an abnormal distribution of the holes in the anodized layer can be prevented. Moreover, the fabricating method of a field emission device array substrate according to the present invention can effectively avoid the generation of undesirable stresses during fabricating the anodized layer. Therefore, the fabricating method of a field emission device array substrate according to the present invention can effectively improve the process yield rate and the reliability of the field emission device array substrate.

In order to make the aforementioned and other objectives, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1D are schematic cross-sectional views of a conventional field emission device array substrate during the fabrication processes.

FIGS. 2A-2F show cross-sectional views of a field emission device array substrate of the present invention during the fabrication processes.

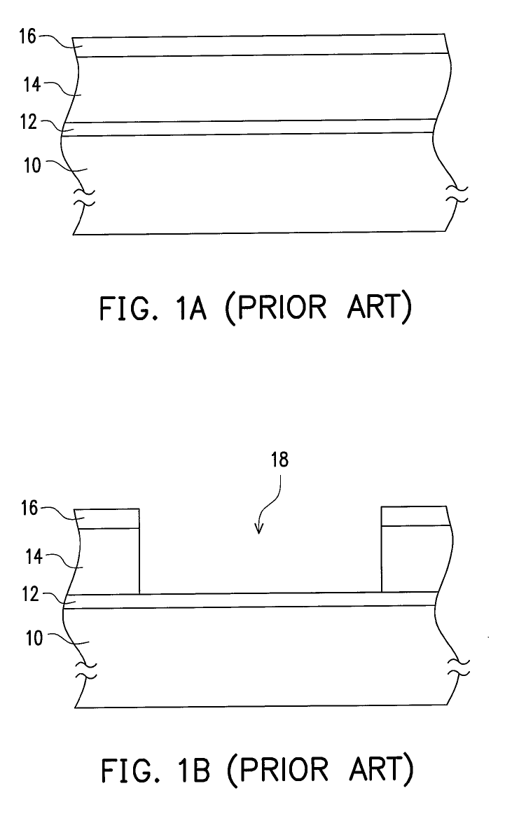

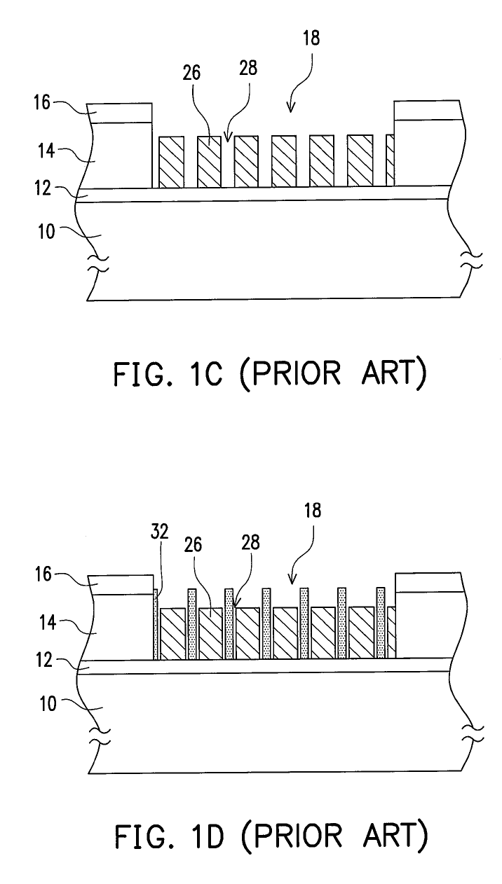

### DESCRIPTION OF EMBODIMENTS

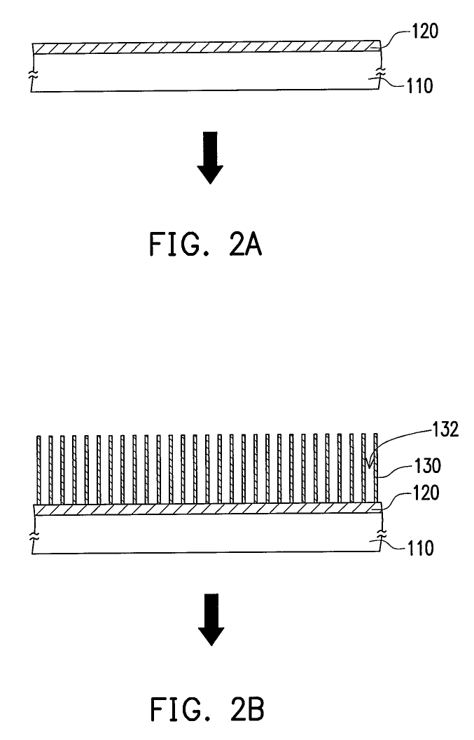

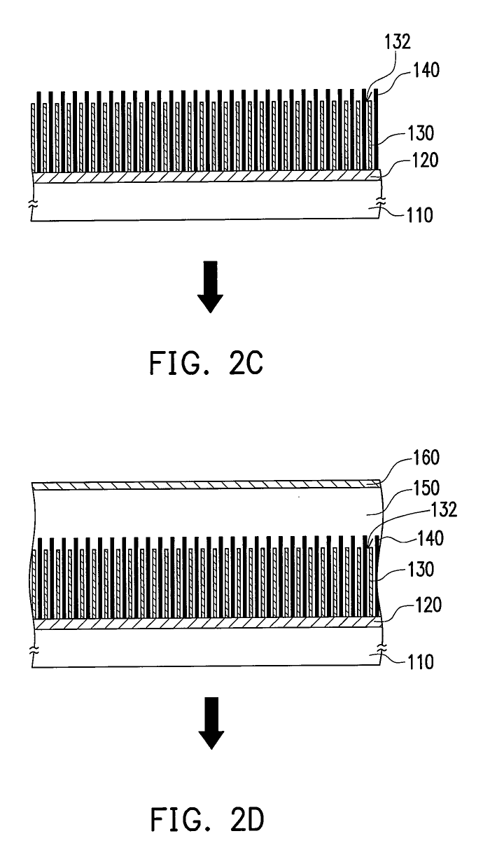

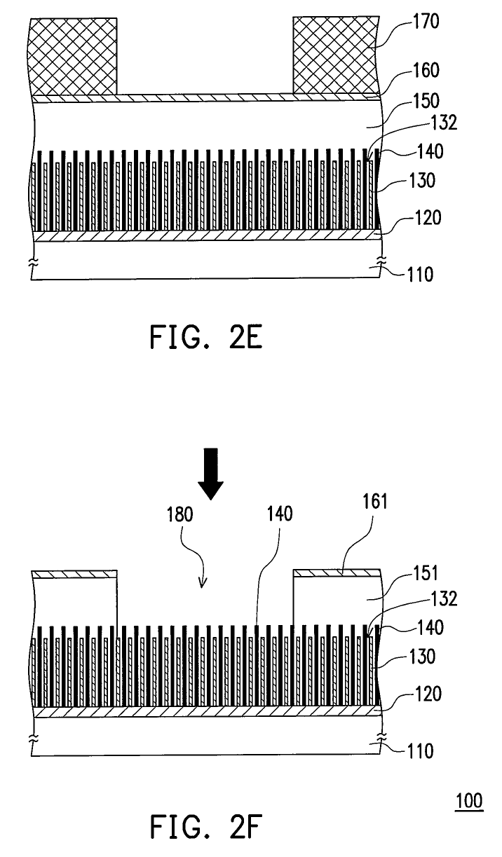

FIGS. 2A-2F show a cross-sectional views of a field emission device array substrate of the present invention during the fabrication processes. Referring to FIG. 2A, at first a substrate 110 is provided. Then, a cathode conductive layer 120 is formed on the substrate 110. Then, referring to FIG. 2B, an anodized layer 130 is formed on the cathode conductive layer 120. The anodized layer 130 has a plurality of holes 132, and the material of the anodized layer 130 is, for example, aluminum oxide.

In an embodiment, the method of forming the anodized layer 130 includes the following steps. A film is deposited on the cathode conductive layer 120 firstly by physical vapor deposition (PVD). Aluminum (or aluminum alloy) is selected as the material of the film, and the thickness of the film is about 2-6 μm. Then, an anodization process is performed on the film (aluminum) to form anodic aluminum oxide (AAO) with a plurality of holes 132. Specifically, the aperture of the holes 132 is, for example, in the range of 40 nm and 100 nm.

More specifically, the electrolyte used in the anodization process is, for example, oxalic acid, the operating temperature is, for example, the room temperature, and the operating voltage is, for example, 40 volts. In order to form holes 132 properly arranged, the aluminum oxide formed initially is removed by a mixture containing 6 wt % (weight percentage) of phosphoric acid and 1.5 wt % of chromic acid at a temperature of 60° C. Then the anodization under the same conditions is performed again to fabricate the anodized layer 130 having the holes 132 with even distribution and verticality.

It should be noted that, the fabricating method of a field emission device array substrate according to the present invention is to fabricate the anodized layer 130 on the cathode conductive layer 120 directly. Compared with the conventional art, the anodized layer 130 of the present invention will not be affected by undesirable stresses, thus the holes 132 with proper distribution and the anodized layer 130 with good reliability can be formed.

Then referring to FIG. 2C, a plurality of electron emitters 140 is formed within the holes 132 respectively. The electron emitters 140 of the present invention include carbon nanotubes. It can be known from FIG. 2C that, the carbon nanotubes are higher than the top of the anodized layer 130. In practice, the tops of the carbon nanotubes are higher than the top of the anodized layer 130 with a height, for example, less than 500 nm. In an embodiment, the electron emitters 140 are formed by chemical vapor deposition. The details are given below. First of all, the metal particles of cobalt (alternative materials are, e.g. metals, such as iron, cobalt, and nickel, alloys thereof, or compounds thereof) are coated on the bottom of the holes 132 of the anodized layer 130 as the catalyst for the growth of carbon nanotubes. The process is conducted under conditions of an operating temperature, e.g. the room temperature, an operating voltage, e.g. 10-13 volts, and a process duration of about one minute. Moreover, the electrolyte used in the process is prepared, for example, by mixing 5 wt % of cobalt sulfate and 2 wt % of boric acid.

Then, the carbon nanotubes are formed within the holes 132 by electron cyclotron resonance-CVD (ECR-CVD). In practice, the process of forming the carbon nanotube is conducted with mixed methane/hydrogen as the reaction gas under conditions of magnetic field intensity being 875 gausses, microwave power of 750 watt, and operating temperature of 600° C. The reaction gas can be selected from gases containing at least one carbon-containing gas, such as carbon monoxide, methane, ethane, propane, ethylene, and benzene, or mixtures thereof. Moreover, the total gas flow rate is 20-30 sccm (standard cubic centimeter per minute).

Then, referring to FIG. 2D, an insulation layer 150 is formed to cover the electron emitters 140 and the anodized layer 130. In practice, the material of the insulation layer 150 includes silicon nitride, silicon oxide, or silicon oxynitride, and the thickness of the insulation layer 150 is about 0.5-3 μm. Then, a gate material layer 160 is formed on the insulation layer 150. The material of the gate layer 160 includes metal, alloy, or doped semiconductor, and the thickness of the gate layer 160 is about 100-600 nm.

Then, referring to FIG. 2E, a patterned photoresist layer 170 is formed on the gate material layer 160. Then, referring to FIG. 2F, the gate material layer 160 is patterned to form a gate layer 161. The gate layer 161 and the insulation layer 151 have an opening 180 formed therein to expose the electron emitters 140. Specifically, the aperture of the opening 180 is, for example, 0.5-20 μm. As described above, the fabrication of the field emission device array substrate 100 of the present invention is substantially completed.

The field emission device array substrate 100 shown in FIG. 2F includes the substrate 110, the cathode conductive layer 120, the anodized layer 130, the electron emitters 140, the insulation layer 151, and the gate layer 161. The cathode conductive layer 120 is disposed on the substrate 110, and the anodized layer 130 is disposed on the cathode conductive layer 120. Moreover, the anodized layer 130 has a plurality of holes 132, and the electron emitters 140 are disposed within the holes 132 respectively. Additionally, the insulation layer 151 covers parts of the anodized layer 130 and parts of the electron emitters 140, and the gate layer 161 is disposed on the insulation layer 151. The insulation layer 151 and the gate layer 161 of the present invention have an opening 180 to expose the electron emitters 140.

As described above, the fabricating method of a field emission device array substrate according to the present invention is to fabricate the anodized layer on the cathode conductive layer directly. Therefore, the anodized layer of the present invention will not be affected by undesirable stresses, thus an abnormal distribution of the holes in the anodized layer can be prevented, and the generation of undesirable stresses can be effectively eliminated. Moreover, the anodized layer is formed before the gate layer is formed, so that the gate layer formed according to the present invention will not affected undesirably by the anodization. Therefore, the field emission device array substrate of the present invention can have good reliability and process yield rate.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fabricating method of a field emission device array substrate, comprising:
providing a substrate;
forming a cathode conductive layer on the substrate;
forming an anodized layer on the cathode conductive layer, wherein the anodized layer has a plurality of holes;
forming a plurality of electron emitters in the holes respectively;
forming an insulation layer to cover the anodized layer and the electron emitters;
forming a gate material layer on the insulation layer; and
patterning the gate material layer to form a gate layer, wherein the gate layer and the insulation layer have an opening to expose the electron emitters.

2. The fabricating method of a field emission device array substrate as claimed in claim 1, wherein the electron emitters comprise carbon nanotubes.

3. The fabricating method of a field emission device array substrate as claimed in claim 1, wherein the method of forming the electron emitters comprises chemical vapor deposition.

4. The fabricating method of a field emission device array substrate as claimed in claim 1, wherein the material of the anodized layer comprises aluminum oxide.

5. The fabricating method of a field emission device array substrate as claimed in claim 1, wherein the material of the insulation layer comprises silicon nitride, silicon oxide, or silicon oxynitride.

6. The fabricating method of a field emission device array substrate as claimed in claim 1, wherein the material of the gate layer comprises metal, alloy, or doped semiconductor.

7. A field emission device array substrate, comprising:
a substrate;
a cathode conductive layer, disposed on the substrate;
an anodized layer, disposed on the cathode conductive layer, and having a plurality of holes;
a plurality of electron emitters, respectively disposed in the holes;
an insulation layer, covering the anodized layer and the electron emitters; and
a gate layer, disposed on the insulation layer, wherein the insulation layer and the gate layer have an opening to expose the electron emitters.

8. The field emission device array substrate as claimed in claim 7, wherein the electron emitters comprise carbon nanotubes.

9. The field emission device array substrate as claimed in claim 7, wherein the material of the anodized layer comprises aluminum oxide.

10. The field emission device array substrate as claimed in claim 7, wherein the material of the insulation layer comprises silicon nitride, silicon oxide, or silicon oxynitride.

11. The field emission device array substrate as claimed in claim 7, wherein the material of the gate layer comprises metal, alloy, or doped semiconductor.
